(19) United States
(12) Patent Application Publication
(10) Pub. No.: US 2016/0055178 A1
(43) Pub. Date: Feb. 25, 2016

(54) METHOD FOR SWIFTLY SEARCHING FOR TARGET OBJECTS

(71) Applicants: INVENTEC (PUDONG) TECHNOLOGY CORPORATION, Shanghai City (CN); INVENTEC CORPORATION, Taipei City (TW)

(72) Inventor: HUANG-HSIANG CHIANG, Taipei City (TW)

(21) Appl. No.: 14/677,369

(22) Filed: Apr. 2, 2015

(30) Foreign Application Priority Data
Aug. 25, 2014 (CN) 201410421380.6

(51) Int. Cl. G06F 17/30; G06K 9/18; G06K 9/62

(52) U.S. Cl. CPC G06F 17/30259; G06K 9/6201; G06K 9/18

(57) ABSTRACT

A method for swiftly searching for target objects is applied on a handheld device. The method comprises a control interface for inputting at least one characteristic of the target object. The handheld device is configured to capture an pictured image of an environment to facilitate the search. The control interface is also provided with the pictured image, whence at least one compared image is obtained and compared with the characteristic. The compared image is labeled with a mark when it matches with the characteristic. A user using the handheld device can find the target object in the environment according to the mark. The method enhances search efficiency and reduces the missing rate of the artificial search for the target object.

### CROSS-REFERENCE TO RELATED APPLICATIONS

This non-provisional application claims priority under 35 U.S.C. § 119(a) on Patent Application No. 201410421380.6 filed in China on Aug. 25^{th}, 2014, the entire contents of which are hereby incorporated by reference.

### BACKGROUND OF THE INVENTION

1. Technical Field of the Invention

The present invention relates to a method for swiftly searching for target objects, particularly to a method for swiftly searching for target objects to recognize a target object in an image.

2. Description of the Related Art

The known search methods for target objects usually need a large amount of manpower. For example, when the search target is a book, it usually needs to classify the books in advance with classification numbers, display the book by its classification, and develop a system to manage the books for users to search. This kind of methods cost not only lots of manpower to organize to books, but also lots of money to maintain the system.

Another method for book organization only uses book classification or press company to classify books. Although this kind of method costs less, however, consumers may miss the books they are looking for and the buying opportunities are lost.

In summary, the known search method for target objects not only has high costs and high manpower consumptions, but also leads to high missing rate of artificial search. According to the said problems, a method for swiftly searching for target objects is needed to reduce labor costs and enhance search efficiency.

### SUMMARY OF THE INVENTION

The present invention provides a method for swiftly searching for target objects to quickly find out the target objects in miscellaneous objects or a plurality of compared objects and to reduce search missing rate.

In order to solve the said problem, the present invention discloses a method for swiftly searching for target objects, comprising: providing a control interface; the control interface obtaining at least one characteristic of a target object; capturing a pictured image of an environment by an image capturing unit of a handheld device; providing the pictured image to the control interface; obtaining at least one compared image of the pictured image; comparing the characteristic with the compared image; and labeling a mark on the compared image for users to find out the target object conveniently when the compared image matches with the characteristic.

In an embodiment, the environment has a plurality of compared objects and the pictured image comprises at least one image of the compared object.

In an embodiment, the step of the control interface obtaining at least one characteristic of a target object further comprises obtaining the characteristic from an input interface of the control interface.

In an embodiment, the step of providing the pictured image to the control interface further comprises instantly displaying the pictured image in a display interface of the control interface.

In an embodiment, the step of obtaining at least one compared image of the pictured image comprises distinguishing the parts corresponding to the compared images in the pictured image.

In an embodiment, the step of obtaining at least one compared image of the pictured image further comprises connecting to a database to search for a related data list of the target object; storing at least one related datum matching with the target object in the related data list; and taking the stored related data as the characteristic of the target object.

In an embodiment, the step of comparing the characteristic with the compared image further comprises determining whether the characteristic is a text or an image; comparing the text in a default hand-writing direction when the characteristic is a text; and comparing the image when the characteristic is an image.

In an embodiment, the characteristic is divided to a first searching characteristic and a second searching characteristic, and in the step of comparing the characteristic with the compared image, the first searching characteristic is used to compare with the compared image by default, and when no matched result is found, the second searching characteristic is used to compare with the compared image.

In summary, the method for swiftly searching for target objects uses a handheld device for users to transform the captured image of the real environment to a virtually pictured image, and uses a control interface to recognize the pictured image and label the location of the target object for searching for the target object quickly and precisely. Therefore, the missing rate of artificial search and the labor costs are reduced.

The contents of the present invention set forth and the embodiments hereinafter are for demonstrating and illustrating the spirit and principles of the present invention, and for providing further explanation of the claims.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a flowchart of a method for swiftly searching for target objects according to an embodiment of the present invention.

FIG. 2 is a flowchart of obtaining a characteristic from an input interface according to an embodiment of the present invention.

FIG. 3 is a diagram of an input interface according to an embodiment of the present invention.

FIG. 4 is a flowchart of recognizing an pictured image in the display interface according to another embodiment of the present invention.

FIG. 5 is a usage diagram of using a handheld device to search for a target book according to another embodiment of the present invention.

FIG. 6 is a diagram of displaying an image-clearness-notification block in the control interface according to another embodiment of the present invention.

FIG. 7 is a diagram of obtaining a compared image in the pictured image according to another embodiment of the present invention.

FIG. 8 is a diagram of labeling a mark on the compared image according to another embodiment of the present invention.

FIG. 9 is a flowchart of searching a compared object in advance according to a further embodiment of the present invention.

FIG. 10 is a diagram of a related data list according to a further embodiment of the present invention.

FIG. 11 is a flowchart of the control interface recognizing the compared image according to a further embodiment of the present invention.

FIG. 12 is a flowchart of searching for the target object according to the search order according to another embodiment of the present invention.

FIG. 13 to FIG. 15 are usage diagrams of the police searching for stolen motorcycles according to another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

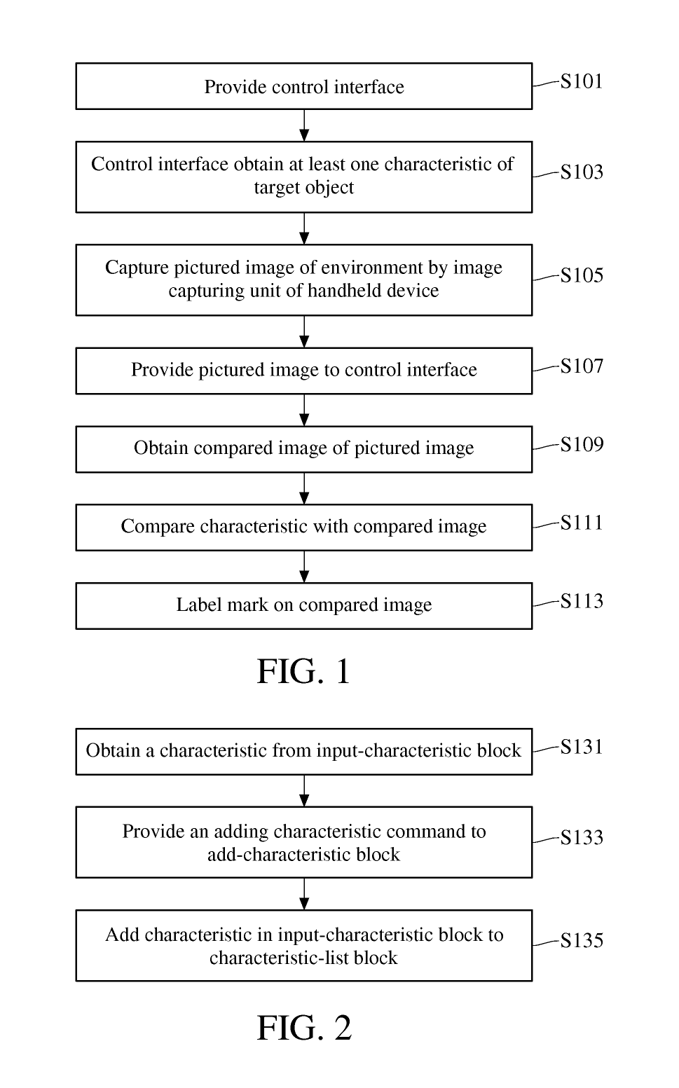

Please refer to FIG. 1. FIG. 1 is a flowchart of a method for swiftly searching for target objects according to an embodiment of the present invention. As shown in FIG. 1, in the step S101, first a control interface is provided in a handheld device, and the handheld device is used to search for target objects in the environment, wherein the handheld device has an image capturing unit to capture the image of the environment. Practically, the handheld device is, for example, a smart phone and the control interface is, for example, an application. The application is installed in the smart phone to search for target objects, and the camera of the smart phone is for the image capturing unit to capture the image of the environment. The present invention does not limit to the previous descriptions.

In the step S103, at least one characteristic of the target object is obtained from the control interface. For example, when the target object is a book, users can input the book name in the control interface for indicating the characteristic of the book. When the target object is a motorcycle, users can input the license plate number for indicating the characteristic of the motorcycle, or any other information suitable for indicating the characteristic of the target object. The present embodiment does not have any limitation.

In the step S105, the pictured image of the environment is captured by the image capturing unit of the handheld device. In the step S107, the control interface can instantly display the pictured image captured by the image capturing unit for users to watch. In the step S109, at least one compared image of the pictured image is obtained from the control interface. For example, when an environment with lots of miscellaneous objects is photographed by the image capturing unit and users want to search for a book in that environment, the control interface determines the images similar to books among the miscellaneous objects and classifies those images to the compared images.

Next, in the step S111, according to the obtained characteristic from the step S103, the control interface compares the compared images and the characteristic. For example, in the step S103, when the book name inputted by users is taken as the characteristic for searching, the book name is compared with the compared images.

Finally, in the step S113, when the compared image matches with the characteristic, a mark is labeled on the compared image. For example, when the compared image of the said book matches with the book name, a mark is labeled on the matched compared image.

In an embodiment, the method for swiftly searching for target objects can be adapted for an office with lots of miscellaneous objects to search for documents having a certain keyword. First, a keyword inputted by users in the control interface is obtained and the keyword is taken as the characteristic. Then, a pictured image of the office is captured by the image capturing unit, and at least one compared image is obtained from the pictured image. The compared images can be all of the text images in the pictured image, and comparing the compared images with the characteristic is comparing the text images with the keyword. When a text image matches with the keyword, a mark is labeled on the text image matching the keyword and adapted for users to quickly search for the matched documents.

The labeled mark includes but not limited to a circle, an ellipse, a rectangle, an arrow indicator, or any other noticeable indicator. The present embodiment does not have any limitation.

In another embodiment, when a plurality of compared objects are in the environment, the image captured by the image capturing unit of the handheld device has a plurality of compared images. Then at least one compared image obtained from the image is compared with the characteristic, and when the compared image matches with the characteristic, a mark is labeled on the matched compared image.

A practical implementation of the present embodiment can be searching for a target book in a bookshelf with a plurality of books. The search method is taking the keyword inputted by users in the control interface and related to the target book as the characteristic, and obtaining the pictured image of the bookshelf and the compared images of the books by the handheld device, and comparing the keyword with the compared images. When the compared image matches with the keyword, a mark is labeled on the matched compared image for users to instantly search for the target books having the keyword in the bookshelf.

In more detail, the control interface further includes an input interface and a display interface, wherein the input interface is for providing users to input the characteristic of the target object, and the display interface is for providing an instant display of the pictured image and displaying a mark on the matched compared image when the compared image matched with the characteristic.

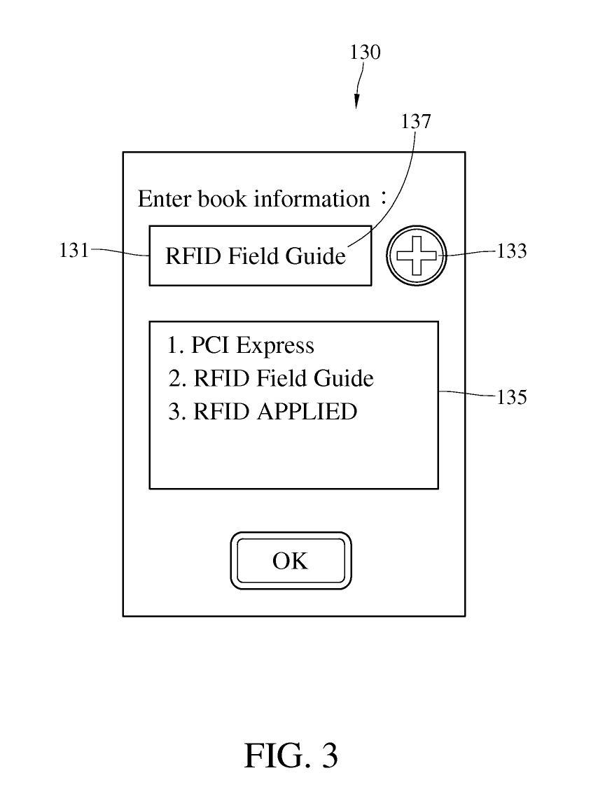

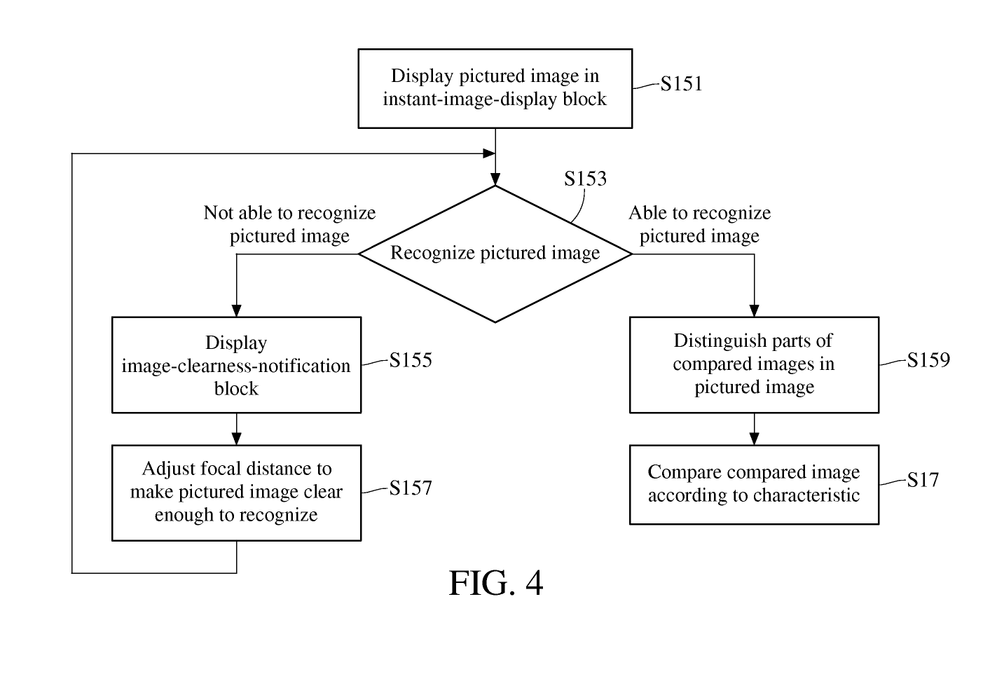

Please refer to FIG. 2 and FIG. 3 together. FIG. 2 is a flowchart of obtaining a characteristic from an input interface according to an embodiment of the present invention. FIG. 3 is a diagram of an input interface according to an embodiment of the present invention. As shown in the figures, the input interface 130 has an input-characteristic block 131, an add-characteristic block 133, and a characteristic-list block 135, wherein the input-characteristic block 131 is for providing users to input the characteristic 137 of the target object, and the add-characteristic block 133 is for adding the characteristic 137 inputted by users to the characteristic-list block 135, and the characteristic-list block 135 is for displaying the inputted characteristic 137 to users.

In the step S131, a characteristic 137 is obtained from the input-characteristic block 131. Then in the step S133, an adding characteristic command is inputted in the add-characteristic block 133. In the step S135, the characteristic 137 is added to the characteristic-list block 135.

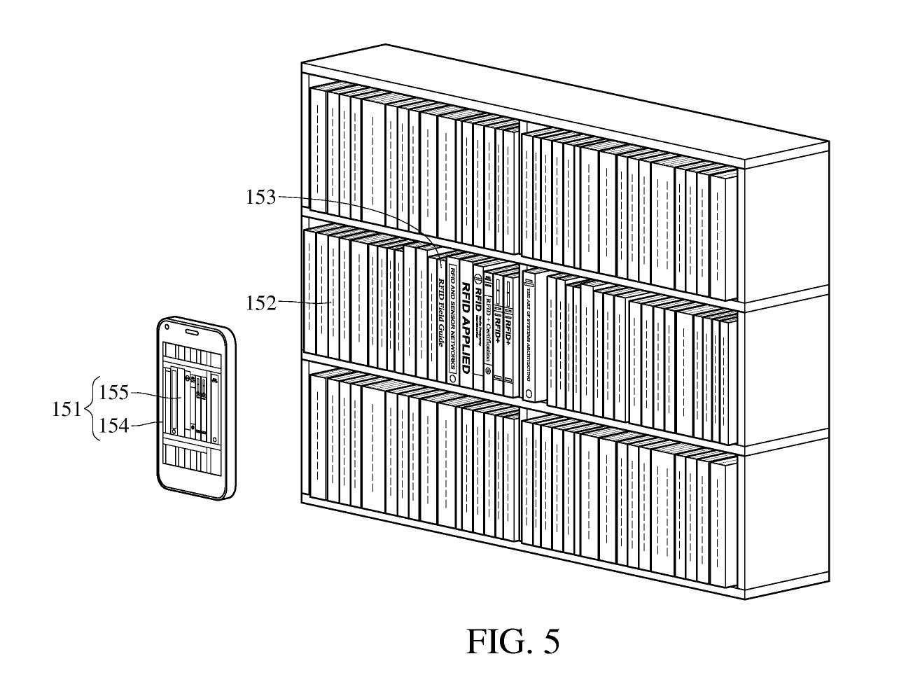

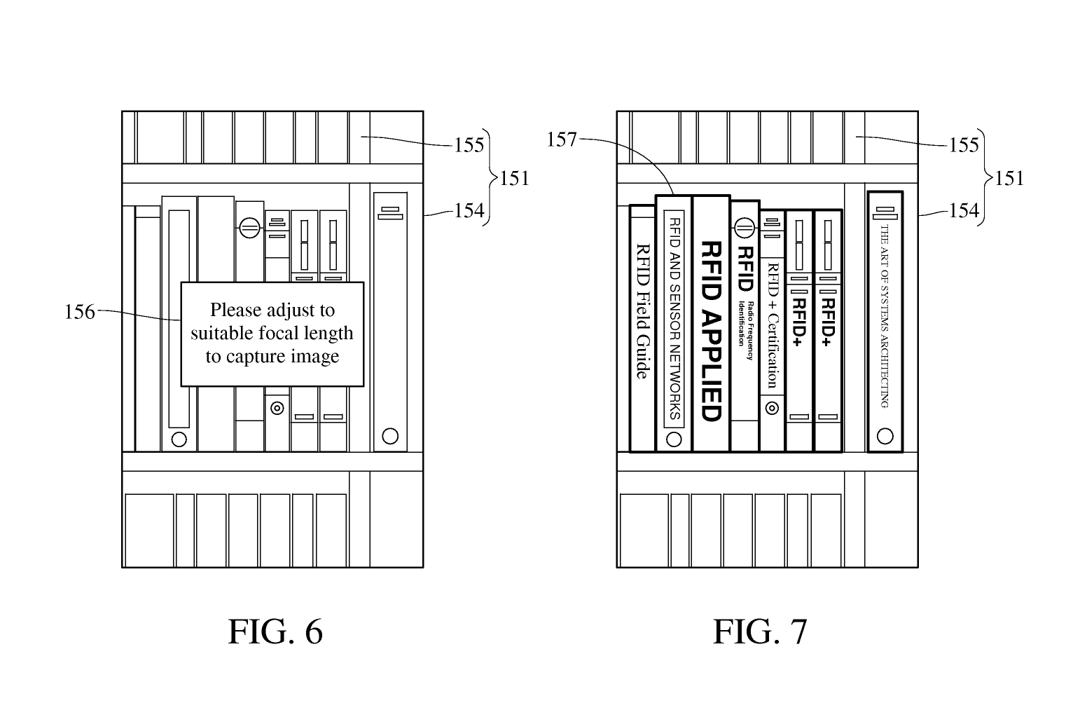

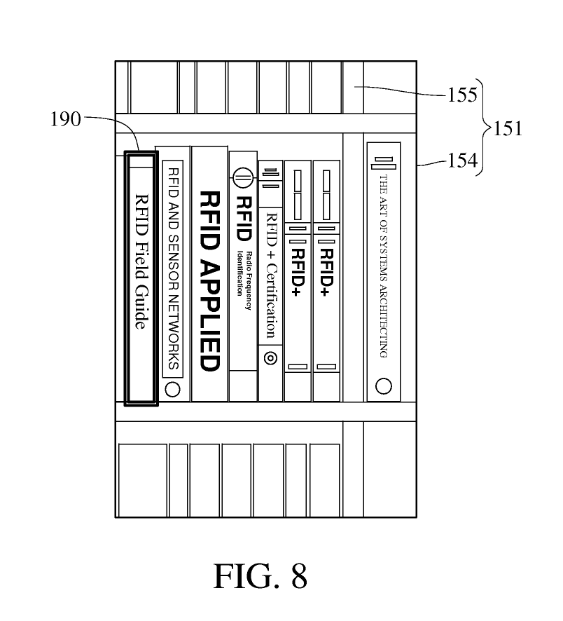

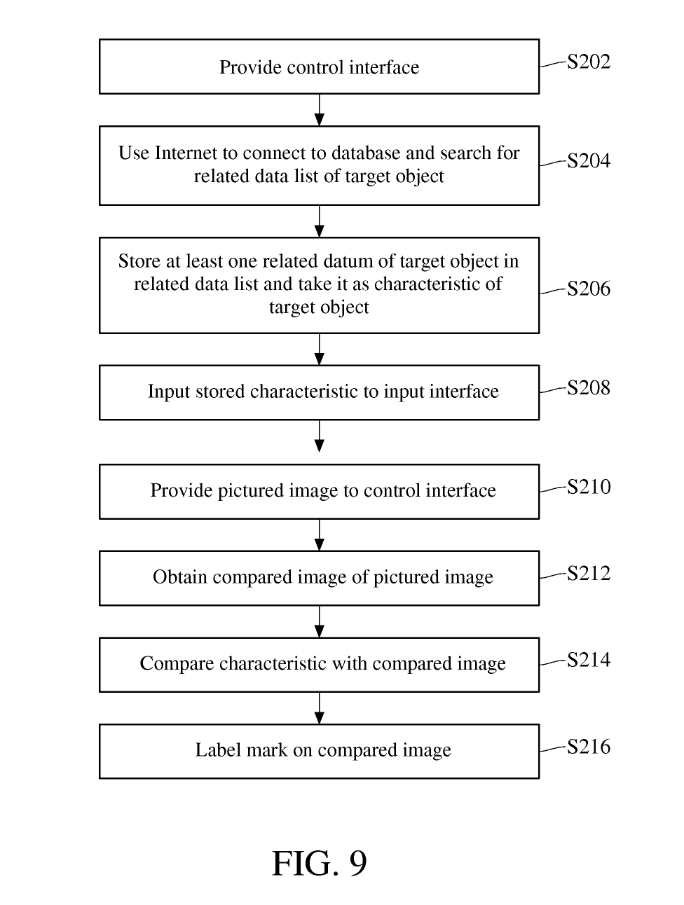

Please refer to FIG. 4 to FIG. 7 together. FIG. 4 is a flowchart of recognizing a pictured image in the display interface according to another embodiment of the present invention. FIG. 5 is a usage diagram of using a handheld device to search for a target book according to another embodiment of the present invention. FIG. 6 is a diagram of displaying an image-clearness-notification block in the control interface according to another embodiment of the present invention. FIG. 7 is a diagram of obtaining a compared image in the pictured image according to another embodiment of the present invention. As shown in these figures, the display interface has an instant-image-display block and an image-clearness-notification block, wherein in the step S151, the instant-image-display block is for instantly displaying the image for users to watch.

Next, in the step S153, the control interface starts to recognize the pictured image. When the control interface can not clearly recognize the pictured image, the procedure enters the step S155 and an image-clearness-notification block is displayed to notification users to adjust the focal distance between the image capturing unit and the environment. Then in the step S157, after the focal distance is adjusted and the pictured image is clear enough for recognition, the step S153 is executed again to make the control interface recognize the pictured image. When the control interface recognizes the pictured image successfully, the procedure enters the step S159 of distinguishing the parts of the compared images in the pictured image, and then enters the step S17 of comparing the compared image according to the characteristic.

In an embodiment, when the method for swiftly searching for target objects is taking a book as its target object, a plurality of books 152 placed in the bookshelf are taken as the compared objects. In this embodiment, according to the previous steps, in the input interface, users can input the characteristic of the target book 153 to the input-characteristic block, and click the add-characteristic block to add the inputted characteristic to the characteristic-list block. After all of the characteristics are inputted, users can send out the data in the characteristic-list block to provide one or multiple characteristics at a time for comparing.

Next, in the display interface 151, the image of the book 152 is photographed in an adequate distance and the pictured image 155 is displayed in the instant-image-display block 154. The control interface starts to execute the image recognition, such as distinguishing the image 155 of the book 152 to the compared image 157 and distinguishing the partition board of the bookshelf to non-compared image. The focal distance is related to the focal length of the image capturing unit, for example, 50 m to 100 m. The present embodiment does not have any limitation.

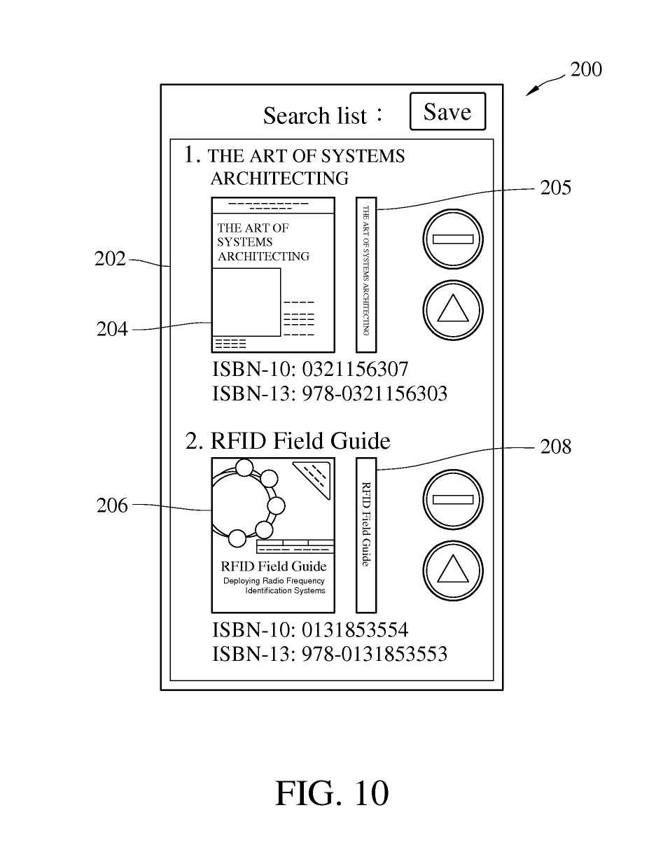

Please refer to FIG. 8. FIG. 8 is a diagram of labeling a mark on the compared image according to another embodiment of the present invention. The compared image is compared with the characteristic obtained from the characteristic-list block. When the compared image matches with the characteristic, a rectangle block or an arrow mark 190 is used to label the matched compared image for reminding users the location of the mark 190 to obtain the target book quickly.

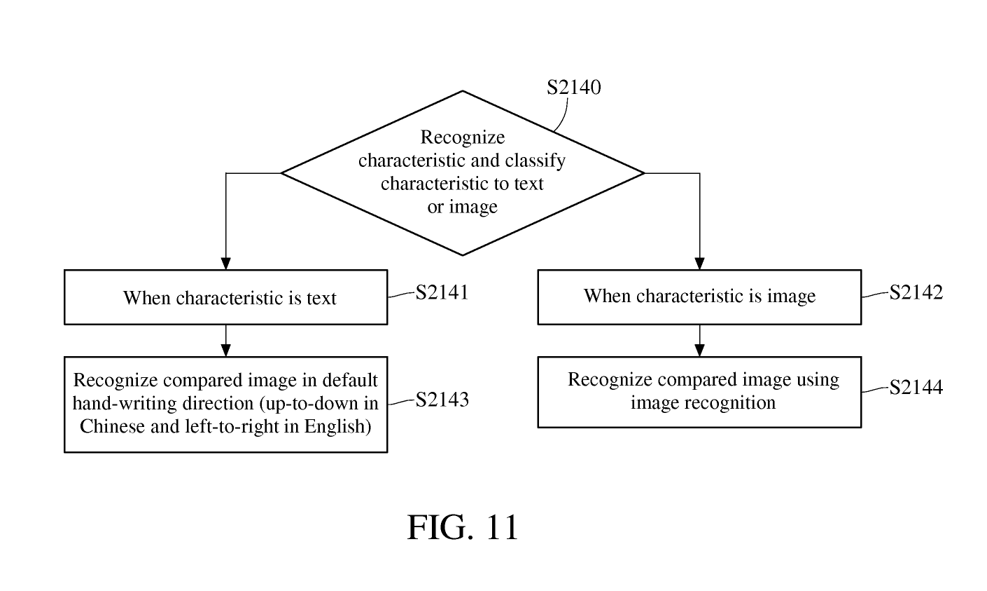

Please refer to FIG. 9. FIG. 9 is a flowchart of searching a compared object in advance according to a further embodiment of the present invention. As shown in FIG. 9, the difference between the present embodiment and the previous embodiment is that the present embodiment further includes the step of searching a compared object in advance.

In the step S202, a control interface is provided for users to search for target objects using a handheld device. The control interface has an information search interface, an input interface, and a display interface. In the step S204, a related data list collected by connecting to a database on the Internet and searching for the information of the target object is displayed on the information search interface. Then in the step S206, at least one related datum matching with the target object in the related data list is stored and the stored related datum is the characteristic of the target object. In the step S208, the stored characteristic is inputted to the input interface. In the step S210, the pictured image is instantly displayed on the display interface for users to watch, and at least one compared image is obtained from the pictured image. In the step S212, the compared image is compared with the characteristic. In the step S214, when the compared image matches with the characteristic, a mark is labeled on the matched compared image.

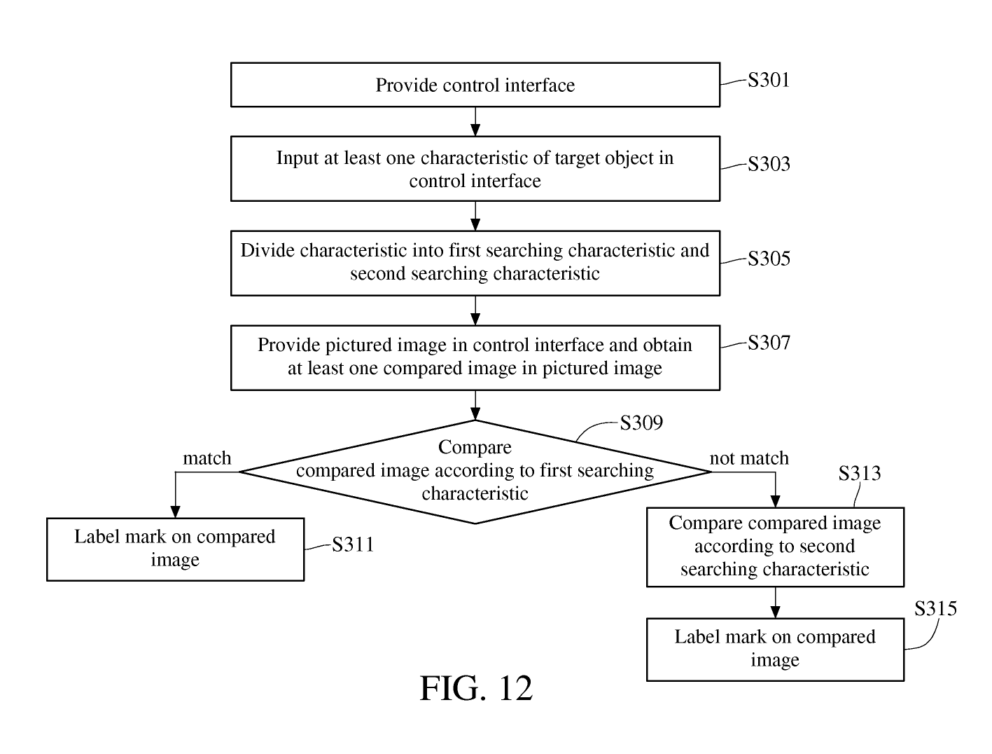

Please refer to FIG. 10. FIG. 10 is a diagram of a related data list according to a further embodiment of the present invention. As shown in FIG. 10, for example, the method for swiftly searching for target objects displays the information of the target books searched from the Internet on the information search interface 200, including: displaying the matched information in the related data list 202 obtained from the searching for the target books from a book database, such as the complete book name, International Standard Book Number (ISBN), book cover 204, or the image of the book back 206. These data are used to be the characteristics 208 of the target book. Then the related data list 202 obtained by searching for target books in a book database is displayed, and the data related to the target books in the related data list 202 are stored, such as the complete book name, ISBN, book cover 204, or the image of the book back 206. These data are used to feature the characteristics 208 of the target book. Next, the control is switched to the display interface and the compared images are obtained from a plurality of books for comparing the characteristic 208 with the compared image. When the compared image matches with the characteristic 208 of the target book, a mark is labeled on the compared image for users to search for the location of the target book quickly.

Although several embodiments are disclosed here, these embodiments are examples and are not for limiting the present invention. Persons skilled in the art can arbitrarily modify any detail of the embodiments.

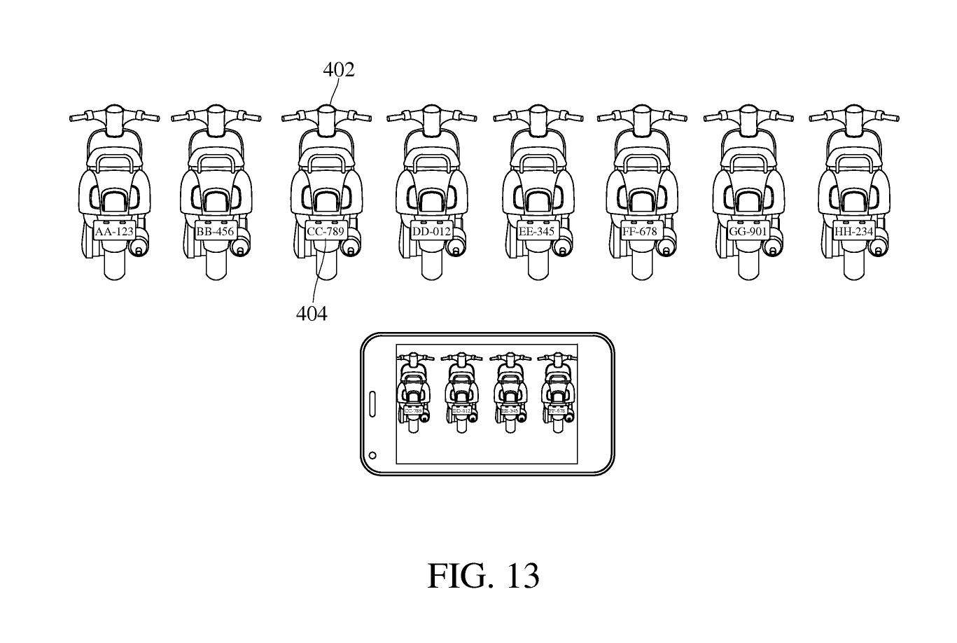

For example, the characteristic can be a text or an image. Please refer to FIG. 11. FIG. 11 is a flowchart of the control interface recognizing the compared image according to a further embodiment of the present invention. As shown in FIG. 11, in the step S2140, the control interface first recognizes whether the characteristic is a text or an image, and then compares the compared image with the characteristic. In the step S2141, when the characteristic is a text, the compared image is recognized to a text and then compared in a default hand-writing direction (such as up-to-down in Chinese and left-to-right in English). In the step S2142, when the characteristic is an image, the step S2144 is adopted to compare the compared image with image recognition.

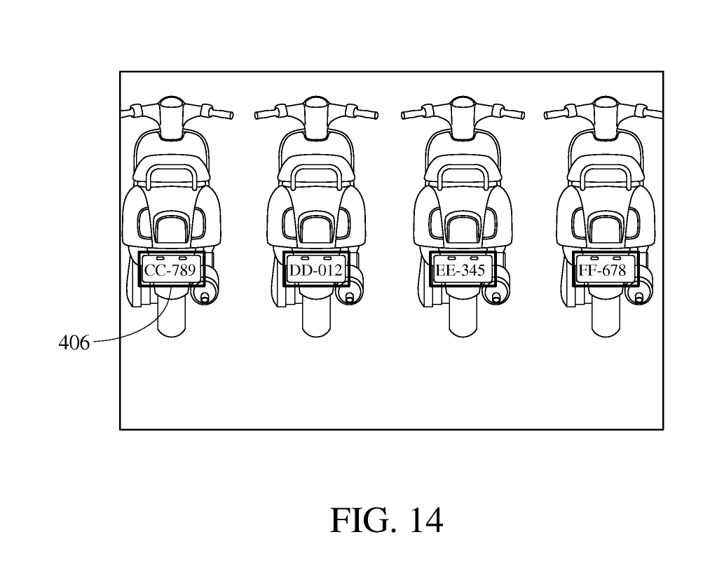

Please refer to FIG. 12. FIG. 12 is a flowchart of searching for the target object according to the search order according to another embodiment of the present invention. In the step S301, a control interface is provided. In the step S303, at least one characteristic of the target object is obtained from the control interface. In the step S305, the characteristic is, by the searching order of the users, divided into a first searching characteristic (such as the classification code) and a second searching characteristic (such as the book name or ISBN). Next, in the step S307, a pictured image is provided in the control interface and at least one compared image is obtained from the pictured image. In the step S309, the compared image is compared according to the first searching characteristic. When the compared image matches with the first searching characteristic, a mark is labeled on the compared image matching with the first searching characteristic in the step S311. When the compared image does not match with the first searching characteristic, the compared image is further compared with the second searching characteristic in the step S313, and when the compared image matches with the second searching characteristic, a mark is labeled on the compared image matching with the second searching characteristic in the step S315.

In addition, the method for swiftly searching for target objects is also available when the compared objects have similar appearances. The following is another embodiment for further explanation.

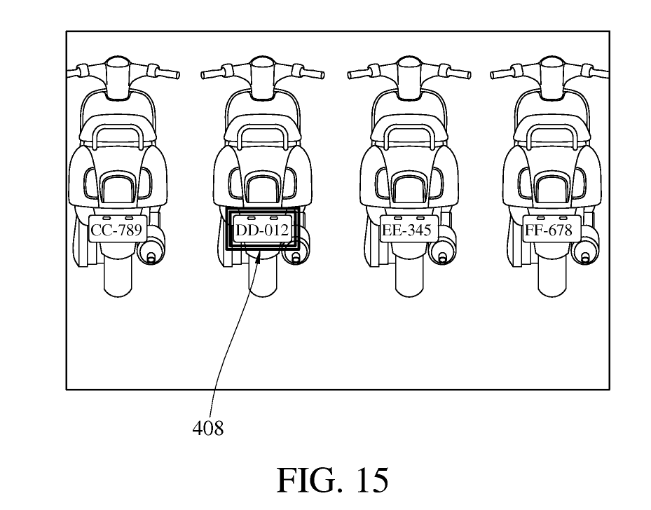

Please refer to FIG. 13 to FIG. 15 together. FIG. 13 to FIG. 15 are usage diagrams of the police searching for stolen motorcycles according to another embodiment of the present invention. As shown in these figures, when the compared objects are a plurality of motorcycles 402, due to the license plate 404 of every motorcycle 402 has similar appearance (such as size), users can input a license plate number to be searched for in the control interface of the handheld device and capture the image of the motorcycle 402. Then the control interface detects the license plate number 404, and takes it as the compared image 406, and compares the compared image 406 with the license plate number of the motorcycle to be searched for, and labels a mark 408 on the compared image 406 when the compared image 406 matches with license plate number to be searched for. The embodiment is provided for police officers to search for stolen motorcycles.

In summary, the method for swiftly searching for target objects uses a handheld device for users to transform the captured image of the real environment to a virtually pictured image, and uses a control interface to recognize the pictured image and label the location of the target object for searching for the target object quickly and precisely. Therefore, the missing rate of artificial search and the labor costs are reduced. The method can be used in all kinds of environments, such as searching for a document in a messy office, finding a book in a bookshelf with lots of books, searching for a motorcycle in a parking lot, or any other situation suitable for using the method for swiftly searching for target objects of the present invention.

What is claimed is:

1. A method for swiftly searching for target objects, comprising:
providing a control interface;
the control interface obtaining at least one characteristic of a target object;
capturing a pictured image of an environment by an image capturing unit of a handheld device;
providing the pictured image to the control interface;
obtaining at least one compared image of the pictured image;
comparing the characteristic with the compared image; and
labeling a mark on the compared image when the compared image matches with the characteristic.

2. The method for swiftly searching for target objects of claim 1, wherein the environment has a plurality of compared objects and the pictured image comprises at least one image of the compared object.

3. The method for swiftly searching for target objects of claim 1, wherein the step of the control interface obtaining at least one characteristic of a target object further comprises:
obtaining the characteristic from an input interface of the control interface.

4. The method for swiftly searching for target objects of claim 1, wherein the step of providing the pictured image to the control interface further comprises:
instantly displaying the pictured image in a display interface of the control interface.

5. The method for swiftly searching for target objects of claim 1, wherein the step of obtaining at least one compared image of the pictured image comprises:
distinguishing the parts corresponding to the compared images in the pictured image.

6. The method for swiftly searching for target objects of claim 1, wherein the step of obtaining at least one compared image of the pictured image further comprises:
connecting to a database to search for a related data list of the target object;
storing at least one related datum matching with the target object in the related data list; and
taking the stored related data as the characteristic of the target object.

7. The method for swiftly searching for target objects of claim 1, wherein the step of comparing the characteristic with the compared image further comprises:
determining whether the characteristic is a text or an image;
comparing the text in a default hand-writing direction when the characteristic is a text; and
comparing the image when the characteristic is an image.

8. The method for swiftly searching for target objects of claim 1, wherein the characteristic is divided to a first searching characteristic and a second searching characteristic, and in the step of comparing the characteristic with the compared image, the first searching characteristic is used to compare with the compared image by default, and when no matched result is found, the second searching characteristic is used to compare with the compared image.
